(19) United States
(12) Patent Application Publication
(10) Pub. No.: US 2008/0110353 A1
(43) Pub. Date: May 15, 2008

(54) Disposable microwave bacon package

(76) Inventor: Kenneth Sims, Austin, MN (US)

Correspondence Address: Kenneth Sims, 1100 NE. 16th Ave, Austin, MN, 55912, US

(21) Appl. No.: 11/906,555

(22) Filed: Oct. 3, 2007

Related U.S. Application Data
(60) Provisional application No. 60/858,538, filed on Nov. 13, 2006.

(51) Int. Cl. A47J 27/00

(52) U.S. Cl. 99/446

(57) ABSTRACT

This disposable bacon cooker eliminates the clean up. This bacon cooker is made of paper or plastic materials that are suitable for use in the microwave oven. This disposable bacon cooker could be incorporated into the packaging and used as a disposable product by the consumer. The layers of bacon are folded into a tent shape and then placed into a tray that supports the tent shape. Most of the prior art of bacon cookers are not disposable.

### CROSS-REFERENCE TO RELATED APPLICATIONS

Claim Filling Date Benefit Of Provisional Patent Application 60/858,538 Filed Nov. 13, 2006

### BACKGROUND OF THE INVENTION

This invention is to eliminate the mess or clean up after cooking bacon and save time.

Bacon cooker is discarded after use. No mess to clean up.

### Discription of Prior Art

U.S. Pat. No. 7,259,360 to Shoulders is a disposable package that converts to a bacon cooker. This package is for the meat processors use not for home use. It may be very expensive and complex to produce. This design requires special tools to stamp out and fold the complex design.

US Pub. Pat. Application 20020185013 by London is a flat disposable bacon cooking tray.

Other prior art found for bacon cookers are not disposable.

### BRIEF SUMMARY OF THE INVENTION

This invention is a disposable bacon cooker that is made of paper, plastic or composite materials that are suitable for use in microwave ovens. It could also be made of material for use in conventional ovens.

The bacon cooker has two pieces: Element A is a flat layer divider or dividers that folds with bacon draped over them and Element B is the tray that the grease drains into as the bacon cooks.

Consumer may use in the home or meat processors could incorporate it into there packaging.

### BRIEF DESCRIPTION OF THE SEVERAL VIEWS OF THE DRAWING

FIG. 1/7 shows element A (the divider) folded into a inverted V shape and set into element B (the tray).

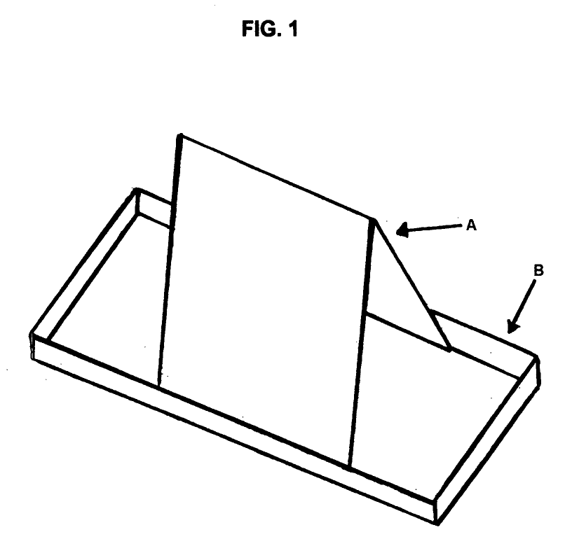

FIG. 2/7 shows element A (the divider) and element B (the tray) separated.

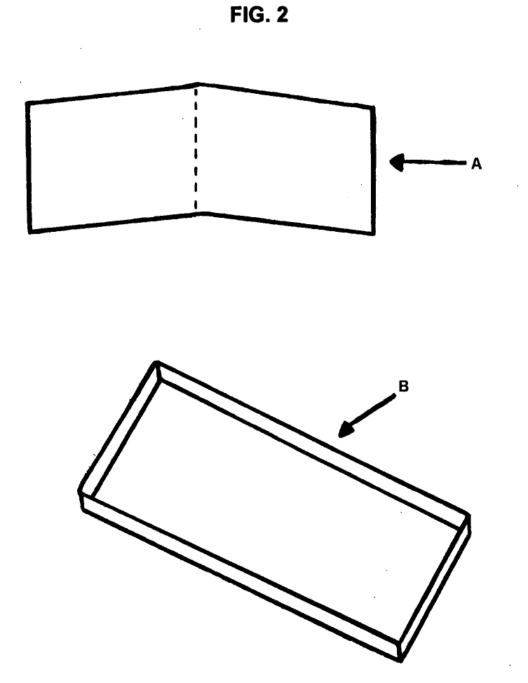

FIG. 3/7 shows element A (the divider) laying almost flat in element B (the tray).

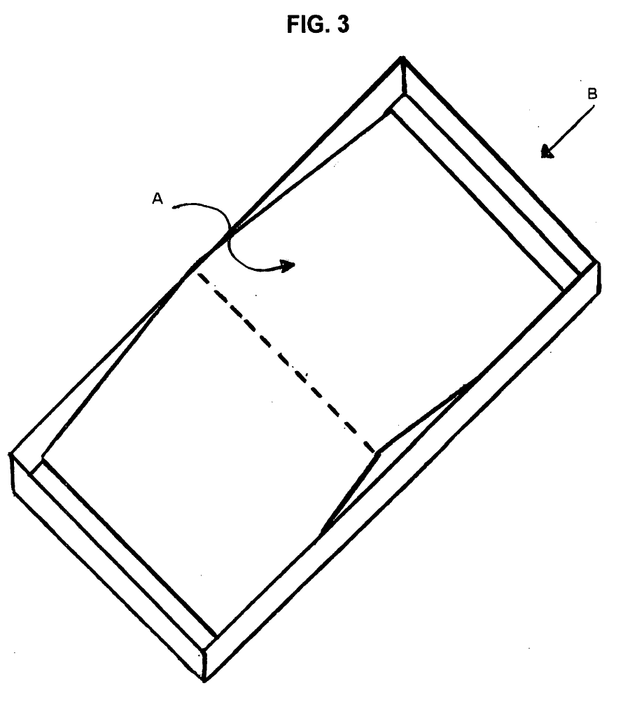

FIG. 4/7 shows two of element A (the dividers) folded and set into element B (the tray) side to side.

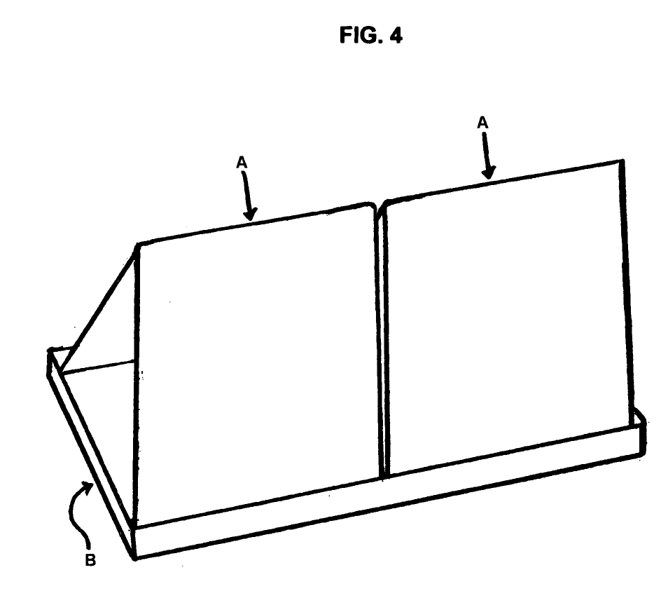

FIG. 5/7 shows two of element A (the dividers) folded and set into element B end to end.

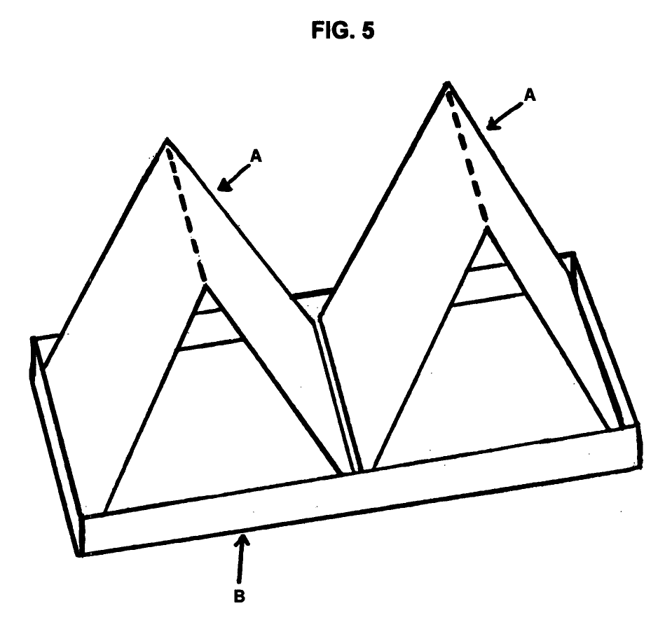

FIG. 6/7 shows element A (the divider) with bacon laying flat in element B (the tray).

FIG. 7/7 shows element A (the divider) with bacon folded and set into element B (the tray).

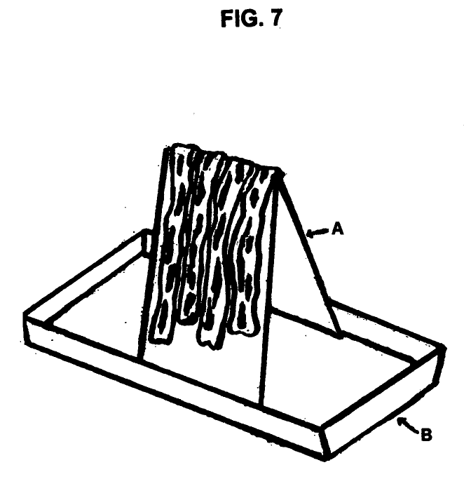

### DETAILED DESCRIPTION OF THE INVENTION

This invention is a disposable bacon cooker that is discarded after cooking the bacon. There are two elements as the drawings show.

Element A is a flat divider that is made from paper, plastic or composite board that when folded at the center fold line into a inverted V shape it will support the bacon strips that are draped over it. This flat divider is of rectangle shape with length and width size about ⅛ inch less than length and width of the tray. Element A is stamped or cut from flat sheets of material and may have a food safe non stick coating.

Element B is the tray that the grease drains into. The sides of the tray must be high enough to support element A in a inverted V shape.

It is best to use a paper towel or absorbent pad in tray bottom to absorb the drained grease. Also it is best to use wax paper or other suitable paper over the bacon to contain grease splatter. The sides of the tray hold the layers of bacon that have been folded into the inverted V shape.

Please refer to the drawings that show the two elements in different configurations depending how element A is placed in element B. The size of the elements suggested in the drawings are about 6 inches wide and 12 inches long.

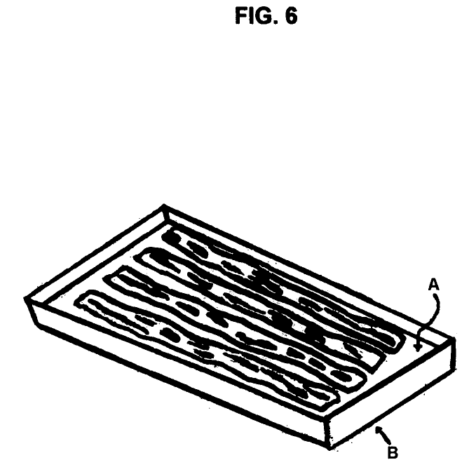

When using this bacon cooker the strips of bacon are placed on the layer dividers as illustrated in drawing FIG. 6/7 the dividers are then folded and set into the tray. The layers may be stacked flat in the tray until they are ready to be cooked.

The consumer may use the disposable cooker at home and meat processors could incorporate it into their packaging of bacon.

1. A disposable apparatus of unique design for the cooking of bacon.
a. A flat rectangle shape is cut or stamped from sheets of thick paper, plastic or other composite material, this piece is stamped with a fold line so it will fold easily in the middle. This piece is called the divider because it divides multiple layers of bacon slices. The dividers may have a non stick coating applied.
b. The bacon is placed on the divider lengthways across the center fold line so when the divider is folded the bacon drapes over the folded divider that is now in the shape of a inverted V.
c. The divider with bacon is set into a tray that is made of paper, plastic or composite materials. The sides of the tray support the inverted V shaped dividers with bacon draped over them. A paper towel or absorbent pad may be placed in bottom of tray to absorb grease. Wax paper may be used over bacon to prevent splatter.
